(19) United States
(12) Patent Application Publication
(10) Pub. No.: US 2011/0281009 A1
(43) Pub. Date: Nov. 17, 2011

(54) MILK-FLAVORED BEVERAGE

(75) Inventors: Kohei Komatsu, Tokyo (JP); Kazuyuki Moteki, Tokyo (JP); Yoshifumi Okumura, Tokyo (JP); Kenji Ikeda, Tokyo (JP)

(73) Assignee: ADEKA CORPORATION, Tokyo (JP)

(21) Appl. No.: 13/146,793

(22) PCT Filed: Mar. 2, 2010
(86) PCT No.: PCT/JP2010/053326

§ 371 Date: Jul. 28, 2011

(30) Foreign Application Priority Data
Mar. 4, 2009 (JP) 2009-051160
Mar. 1, 2010 (JP) 2010-044226

(51) Int. Cl. A23C 9/156; A23F 5/46; A23C 9/20; A23C 21/00

(52) U.S. Cl. 426/548; 426/583; 426/594

(57) ABSTRACT

A novel milk-flavored beverage containing no milk protein and no milk fat and yet having the flavor of milk. It contains whey mineral, particularly whey mineral with a calcium content of less than 2 mass % relative to the solids content of the whey mineral, preferably in an amount of 0.1 to 5 mass %, more preferably 0.3 to 2.5 mass %, on a solid basis, a sweetener preferably including partly or wholly lactose or a high intensity sweetener preferably in an amount of 0.08 to 12 mass %, more preferably 0.2 to 6 mass %, on a sucrose sweetness equivalent basis, and substantially no protein and substantially no fat and oil.

### TECHNICAL FIELD

This invention relates to a novel milk-flavored beverage containing neither milk protein nor milk fat and yet having the flavor of milk.

### BACKGROUND ART

Milk is a very nutritious and tasty food and is consumed in large quantities in beverages and processed foods. Milk comprises nonfat milk solids, such as milk proteins and lactose, milk fats, and water. The taste of milk is regarded to be attributable to milk proteins and milk fats. It has been said that milk with higher milk protein and milk fat contents is tastier.

However, milk has disadvantages for use as a beverage, such as relative subtleness of flavor and perishableness due to its high protein content. For use in food processing, milk is of limited utility because it is a liquid white turbid due to fat and with a high water content and is therefore not easy to use in food and beverage applications requiring clarity or valuing color tone. Additionally, milk is relatively expensive.

In the light of the above problems, it is generally followed practice that inexpensive nonfat dried milk, as nonfat milk solids, and inexpensive animal and plant fats and oils, as a substitute for milk fats, are emulsified to provide oil-in-water emulsion type milk beverages or that, for use in food processing, milk is replaced with dairy products obtained by reducing the water content of milk by drying, dehydration, concentration, or a like means to have an increased milk protein content or milk fat content, such as total milk protein, casein, whey protein, cream, butter, and powdered whole milk.

Nevertheless, the above mentioned milk beverages are by necessity thin and unbalanced in flavor and therefore not tasty. Although the above described dairy products are supposed to have a concentrated flavor and body of milk, some of them have their flavor deteriorated and some others have their body lost during a drying or dehydration step. It has thus been difficult to obtain milk beverages and processed foods with a well-balanced milk flavor.

In particular, coffee beverages containing a dairy product have the problem that the dairy product is subject to denaturation by an acid component of coffee and, when canned and sold hot, the milk component is liable to deteriorate in flavor quickly.

Whey mineral is another milk component with a concentrated body of milk. Whey mineral is usually not eaten alone because of its extremely strong bitterness. It is known that adding whey mineral to food and beverage generally causes an unpleasant smell as described, e.g., in patent literature 1 below. On the other than, it has been introduced that adding whey mineral to an oil-in-water emulsion containing milk protein imparts the body of milk as disclosed, e.g., in patent literature 2 below.

While it is unclear why the same substance imparts different flavors to different foods, seeing that the oil-in-water emulsion of patent literature 2 contains a larger amount of nonfat dried milk as nonfat milk solids than milk and also a large amount (about 40%) of edible fats and oils, it is considered that whey mineral added to a food having high contents of nonfat milk solids and fats and oils enhances the flavor and body of these ingredients.

It is also known that whey mineral having a specific composition or prepared through a specific process is, when added to a beverage or a food in a very small amount, capable of enhancing the saltiness of the food or beverage without changing the flavor, changing the sharp flavor of the food or beverage to a well-balanced flavor as a whole, or masking a too strong flavor of the food or beverage as disclosed, e.g., in patent literature 3 through 8 shown below. However, the effects discussed above are not expected in the case of milk because milk is not included under any category of the foods and beverages discussed.

In recent years, there has been a strong demand for foods and beverages with reduced calories. In this connection, milk is generally deemed to be a high calorie food because of the high fat and protein contents. For this reason, low-fat milk and low-calorie milk are now produced, and proposals on the improvement of the flavor of such processed milk products have been made as disclosed, e.g., in patent literature 9 below. However, low-calorie milk tastes lacking in body on account of the reduced fat and protein contents, which are the base of the taste of milk. Furthermore, since these milk beverages have the same appearance as milk, they have the same limited utility problem as milk in food processing because they are not easy to apply to foods and beverages requiring clarity or valuing color tone.

Accordingly, it has been an issue in the field of foods to develop beverages tasting the same as milk with a reduced milk fat or milk protein content and even with substantially no milk fat nor milk protein.

### Citation List

### Patent Literature

### Patent Literature 1: JP 10-28540A

### Patent Literature 2: JP 2003-299450A

### Patent Literature 3: JP 2008-054662A

### Patent Literature 4: JP 2008-054663A

### Patent Literature 5: JP 2008-054664A

### Patent Literature 6: JP 2008-054665A

### Patent Literature 7: JP 2008-054666A

### Patent Literature 8: JP 2008-054667A

### Patent Literature 9: JP 2002-253116A

### SUMMARY OF THE INVENTION

### Problem to be Solved by the Invention

An object of the invention is to provide a milk-flavored beverage that contains substantially no protein and substantially no fat and oil and yet tastes the same as milk.

### Means for Solving the Problem

To achieve the above object, the inventors have conducted extensive investigations and found as a result that an aqueous solution having dissolved therein whey mineral, particularly whey mineral having a reduced calcium content, and a sweetener unexpectedly tastes almost the same as milk despite of being a clear solution and containing no milk fat and no milk protein that are regarded as the base of the taste of milk.

Having been completed based on the above finding, the present invention provides a milk-flavored beverage characterized by containing whey mineral and a sweetener and containing substantially no protein and substantially no fat and oil.

The invention also provides a food or beverage containing the milk-flavored beverage.

The invention also provides a milk beverage having milk partly substituted with the milk-flavored beverage.

The invention also provides a method of producing foods and beverages containing milk. The method includes substituting part of the milk with the milk-flavored beverage.

### EFFECT OF THE INVENTION

The milk-flavored beverage of the invention has the same flavor as milk even though it contains substantially no protein and substantially no fat or oil. The milk-flavored beverage is of broad utility and applications in processing a variety of foods and beverages.

### BEST MODE FOR CARRYING OUT THE INVENTION

The milk-flavored beverage of the invention will be described in detail with reference to its preferred embodiments. The whey mineral that can be used in the invention will be described first.

Whey mineral is a substance remaining after removing proteins and lactose as much as possible from milk or whey. Therefore, whey mineral contains ash (minerals) in high concentration and is characterized by an extremely high proportion of ash in its solids content. The mineral composition of whey mineral is close to that of the milk or whey from which it is obtained.

The whey mineral that can be used in the invention preferably has high purity, i.e., a low content of impurities, such as proteins and lactose, in order to obtain a particularly clear and no-turbid milk-flavored beverage and a milk-flavored beverage having particularly broad utility in food processing. Specifically, it is preferred to use whey mineral having an ash content of at least 30% relative to its solids content. It is more preferred to use whey mineral with an ash content of 50% or higher relative to its solids content. The higher the ash content, the better.

The whey mineral for use in the invention preferably has a calcium content of less than 2% by mass, more preferably less than 1% by mass, even more preferably less than 0.5% by mass, relative to the solids content of the whey mineral so as to provide a milk-flavored beverage having a particularly appealing milk flavor, high clarity, and good preservability (non-liability to form sediment or turbidity) and being not liable to form a sediment or turbidity even upon heating for sterilization or when used in foods or beverages subject to heating. The lower the calcium content, the better.

Whey mineral produced from milk in a usual manner has a calcium content of 5% by mass or more on a solid basis. Whey mineral with a calcium content less than 2% by mass may be obtained by using acid whey from milk having a previously reduced calcium content in preparing whey mineral by removing lactose and proteins from milk or whey by membrane separation and/or ion exchange followed by cooling or by inserting the step of removing calcium in the preparation of whey mineral from sweet whey. From the standpoint of efficiency and cost in industrial production, it is preferred to employ the method including the step of calcium removal after the minerals are concentrated to some extent in the preparation of whey mineral from sweet whey. The means for removing calcium is not particularly limited, and any known methods may be employed, such as precipitation by maintaining the whey mineral at a controlled temperature.

The content of the whey mineral in the milk-flavored beverage of the invention is preferably 0.1% to 5%, more preferably 0.3% to 2.5%, even more preferably 0.4% to 1.4%, by mass on a solid basis. When the whey mineral content is less than 0.1 mass %, the milk flavor will not be present. When it is more than 5 mass %, the resulting beverage will not have the milk flavor and, on the contrary, will taste very bitter and give off an unpleasant flavor.

The sweetener for use in the invention will then be described.

As used herein, the term “sweetener” denotes a compound or a composition to be added to foods and beverages primarily for the purpose of imparting sweetness to foods and beverages. As used herein, the term “high intensity” refers to the intensity of sweetness about 50 times the sweetness of sucrose or even higher.

Examples of the sweeteners for use in the invention include sugars and sugar alcohols, such as lactose, glucose, fructose, sucrose, maltose, enzyme-saccharified starch syrup, reduced starch saccharification products, reduced starch syrup, high fructose corn syrup, glycosyl sucrose, oligosaccharides, reduced sugar polydextrose, reduced palatinose, sorbitol, reduced lactose, L-arabinose, trehalose, xylose, xylitol, maltitol, erythritol, mannitol, fructo-oligosaccharide, soybean oligosaccharide, galacto-oligosaccharide, lactosucrose, xylo-oligosaccharide, raffinose, lactulose, palatinose, and palatinose oligosaccharide; and high intensity sweeteners, such as sucralose, acesulfame potassium, stevia, aspartame, neotame, thaumatin, glycyrrhizin, saccharin, and Luo han guo. These sweeteners may be used either individually or in combination of two or more thereof.

The content of the sweetener in the milk-flavored beverage of the invention is preferably 0.08% to 12%, more preferably 0.2% to 6%, even more preferably 0.5% to 2.5%, on a sucrose sweetness equivalent basis, which corresponds to preferably 0.00001% to 25%, more preferably 0.000025% to 20%, even more preferably 0.00006% to 15%, by mass based on the milk-flavored beverage. As used herein, the term “sweetness” in “sucrose sweetness equivalent” refers to a measure indicative of the strength of sweet sensation and is usually expressed in terms of the number of times a sweetener other than sucrose is sweeter than sucrose using a sucrose solution as a standard, with the sweetness of sucrose taken as “1”.

When the milk-flavored beverage of the invention is requested to have almost the same taste as milk, it is preferred to use lactose chosen from among the above described sweeteners as part of or the whole of the sweetener. Specifically, lactose is preferably used in an amount of 10% to 100%, more preferably 30% to 100%, even more preferably 100%, relative to the total sweetener on a sucrose sweetness equivalent basis. When lactose is used as a sole sweetener, the lactose content in the milk-flavored beverage is preferably 0.5% to 20%, more preferably 1% to 10%, even more preferably 3% to 7%, by mass.

When the milk-flavored beverage of the invention is requested to have a low calorie content, it is preferred to choose a high intensity sweetener form among the above described sweeteners for use as part of or the whole of the sweetener. Specifically, the content of such a high intensity sweetener in the milk-flavored beverage is preferably 10% to 100%, more preferably 30% to 100%, even more preferably 100%, relative to the total sweetener on a sucrose sweetness equivalent basis.

In the case of using a high intensity sweetener, it is preferred to choose acesulfame potassium and/or sucralose, particularly a combination of acesulfame potassium and sucralose, so as to provide a milk-flavored beverage with a better milk flavor.

When in using acesulfame potassium as a sole high intensity sweetener, the content of acesulfame potassium in the milk-flavored beverage is preferably 0.0004% to 0.06%, more preferably 0.0008% to 0.03%, even more preferably 0.0025% to 0.0125%, by mass. When in using sucralose alone, the content of sucralose is preferably 0.00013% to 0.02%, more preferably 0.00033% to 0.01%, even more preferably 0.0008% to 0.004%, by mass. When in using both acesulfame potassium and sucralose, their amounts to be used are decided in proportion to the mixing ratio.

Lactose and a high intensity sweetener may be used in combination. In this case, the mixing ratio is decided according to the desired palatability of the milk flavor and the desired calorie content.

In the invention particularly when the milk-flavored beverage is required to be prevented from browning on heating for, for example, sterilization or when the food or beverage containing the milk-flavored beverage is held heated while being distributed and sold, it is preferred to use one or more of sucrose (which is non-reducing sugar), sugar alcohols, and high intensity sweeteners, particularly a combination of a sugar alcohol and a high intensity sweetener as part of or the whole of the sweetener. Specifically, the content of the thus chosen sweetener(s) in the milk-flavored beverage is preferably 30% to 100%, more preferably 50% to 100%, even more preferably 100%, relative to the total sweetener on a sucrose sweetness equivalent basis.

In the case of using one or more of sucrose, sugar alcohols, and high intensity sweeteners, particularly a combination of a sugar alcohol and a high intensity sweetener, it is preferred to use one or more of water-soluble dietary fibers included in the gelling agents, stabilizers, and dextrins hereinafter listed as “other ingredients” for the purpose of adjusting perception of sweetness. Examples of the water-soluble dietary fiber include alginic acid, alginic acid salts, pectin, LM pectin, HM pectin, algae extract, agar, glucomannan, locust bean gum, guar gum, gellan gum, tragacanth gum, xanthan gum, carrageenan, curdlan, tamarind seed gum, karaya gum, tara gum, gum arabic, cassia gum, methyl cellulose, carboxymethyl cellulose, polydextrose, cyclic dextrin, and indigestible dextrin. Preferred of them are polydextrose and/or indigestible dextrin in view of a relatively small molecular weight and a relatively narrow molecular weight distribution, which contribute to good results.

The amount of the gelling agent, stabilizer, or dextrin to be added varies depending on the kind and amount of the sugar alcohol or high intensity sweetener as well as the kind of the gelling agent, stabilizer, or dextrin. Taking, for example, polydextrose and/or indigestible dextrin, the amount to be added is preferably 0.01% to 10%, more preferably 0.1% to 8%, even more preferably 0.5% to 5.0%, by mass based on the milk-flavored beverage.

The ratio of the sweetener to whey mineral is preferably 0.5 parts by mass or more, more preferably 1.0 part by mass or more, of the sweetener per part by mass of the solids content of the whey mineral on a sucrose sweetness equivalent basis. With less than 0.5 parts by mass, the bitterness and unpleasant odor of whey mineral might be perceived. While there is no particular upper limit, the sweetener is preferably used in an amount of not more than 50 parts by mass on a sucrose sweetness equivalent basis.

The milk-flavored beverage of the invention contains substantially no protein and substantially no fat and oil.

As previously stated, ordinary milk beverages or milk-like beverages have been considered to be lacking in milk flavor unless they contain milk protein and milk fat. To the contrary, the milk-flavored beverage of the invention is characterized by tasting similarly to milk in spite of not only the absence of milk fat and milk protein but also the absence of any fat and oil other than milk fats and the absence of any protein other than milk proteins. Therefore, the milk-flavor beverage of the invention is unique in that, unlike milk, it is a clear solution with no turbidity and has a good flavor of milk.

As used herein, the expression “clear and with no turbidity” is intended to mean to have an absorbance of 0.1 or less, preferably 0.05 or less, more preferably 0.01 or less, even more preferably 0.001 or less, at a wavelength of 660 nm as measured with a spectrophotometer.

As used herein, the term “substantially no protein” means that a protein content is 1.0% by mass or less, preferably 0.5% by mass or less, even more preferably 0.3% by mass or less, the protein content being obtained by multiplying total nitrogen determined by the Kjeldahl method by a factor of 6.38. When the protein content exceeds 1.0 mass %, the product tends to fail to be a clear milk-flavored beverage and, when used in food processing, tends to make the flavor of the food (or beverage) to which it is added dull by the buffering action of protein. Furthermore, the demand for low calorie foods is not fulfilled.

As used herein, the term “substantially no fat and oil” means that a fat and oil content is less than 1.0% by mass or less, preferably 0.5% by mass or less, even more preferably 0.3% by mass or less, the fat and oil content being determined by the Roese-Gottlieb method. When the fat and oil content exceeds 1.0 mass %, the product tends to fail to be a clear milk-flavored beverage, and has less utility in food processing due to problems related to emulsification. Furthermore, the demand for low calorie foods is not fulfilled.

The milk-flavored beverage of the invention may contain other ingredients commonly used in ordinary milk beverages or milk-like beverages as long as the effects of the invention are not impaired. Examples of useful other ingredients include gelling agents or stabilizers, such as alginic acid, alginic acid salts, pectin, LM pectin, HM pectin, algae extract, agar, glucomannan, locust bean gum, guar gum, gellan gum, tragacanth gum, xanthan gum, carrageenan, curdlan, tamarind seed gum, karaya gum, tara gum, gum arabic, cassia gum, methyl cellulose, carboxymethyl cellulose, and polydextrose; naturally-occurring emulsifiers, such as lecithin and enzyme-modified lecithin; emulsifiers, such as glycerol fatty acid esters, glycerol acetic acid fatty acid esters, glycerol lactic acid fatty acid esters, glycerol succinic acid fatty acid esters, glycerol diacetyl tartaric acid fatty acid esters, sorbitan fatty acid esters, sucrose fatty acid esters, sucrose acetic acid isobutyric acid ester, polyglycerol fatty acid esters, polyglycerol condensed ricinoleic acid esters, propylene glycol fatty acid esters, calcium stearoyl lactate, sodium stearoyl lactate, and polyoxyethylene sorbitan fatty acid esters; metal ion scavengers; salting agents, such as common salt and rock salt; inorganic salts; organic salts; diglycerides; plant sterol; plant sterol esters; dextrins, such as linear dextrin, branched dextrin, cyclic dextrin, and indigestible dextrin; taste components, such as flavors, bittering agents, and seasonings; food colorings; preservatives; antioxidants; pH regulators; and enhancers.

The content of these other ingredients is preferably 10% by mass or less, more preferably 5% by mass or less.

The method for making the milk-flavored beverage of the invention is not particularly limited. The milk-flavored beverage of the invention may be obtained by homogeneously dissolving whey mineral, the sweetener, and, if desired, the above described other ingredients in water.

Since, as described supra, the milk-flavored beverage obtained by using whey mineral having a calcium content of less than 2 mass % based on the solids content does not generate sediment or turbidity even if heat-sterilized, it is, where needed, allowed to be subjected to heat sterilization or pasteurization, such as UHT, HTST, or LTLT pasteurization, batchwise, retort, or microwaving, using either a direct heating system, such as injection or infusion, or an indirect heating system, such as a plate, a tube, or a surface-scraped heat exchanger.

The aforementioned milk-flavored beverage of the invention is characterized by being clear with no turbidity unlike milk and yet tasting similarly to milk in spite of the substantial absence of not only milk proteins and milk fats but also other fats and oils and other proteins. Additionally, it has a lower calorie content than milk.

With such characteristics, the milk-flavored beverage of the invention is full of surprises when drunk as it is and, when used in food processing, is of broad utility because of applicability to foods and beverages requiring clarity or transparency and foods and beverages valuing color tone. In other words, the foods and beverages containing the milk-flavored beverage of the invention are preferably those requiring clarity or featuring its color tone.

In applications to beverages, the milk-flavored beverage of the invention, when mixed with clear beverages, such as clear fruit beverages, lemon soda, carbonated drinks, distilled spirit, beer, whisky, and liqueur, does not form turbidity nor impair the color inherent to the clear beverages or, when mixed with beverages having a dark color, such as coffee, tea, green juice, hot chocolate, and black vinegar, does not affect the color tone of the beverages.

When mixed with coffee to provide coffee beverages, in particular, the milk-flavored beverage of the invention is advantageous in that it is free from milk proteins that are susceptible to denaturation by the acid contained in coffee or by heat and free from fats and oils that are susceptible to oxidation and therefore does not undergo deterioration in quality during long-term storage, hot distribution, and hot sale. Besides, such coffee beverages are markedly distinctive in that they assume the color of black coffee and yet taste like coffee with milk.

In one embodiment of the applications to beverages, the milk-flavored beverage of the invention may be mixed with milk. That is, the milk-flavored beverage may be used as a substitute for a part, preferably 20% to 80% by mass, of milk to provide milk beverages. Although the resulting milk beverages have smaller contents of milk proteins and milk fats than milk, they have almost the same taste as milk and yet offer fewer calories.

The milk-flavored beverage of the invention and the milk beverage containing the milk-flavored beverage of the invention as a substitute for a part of milk may be used to substitute for a part of or the whole of milk in those foods or beverages which are usually manufactured using milk. In these cases, although the resulting foods or beverages have smaller contents of milk proteins and milk fats than those prepared using milk, they have almost the same taste as those prepared using milk and yet offer fewer calories.

In the manufacture of foods or beverages generally prepared using milk, whey mineral and a sweetener may be mixed, in place of milk, with other materials in mixing ratios that result in the same composition as does the addition of the milk-flavored beverage of the invention. The point is that it is enough for whey mineral and the sweetener to be present co-dissolved in the aqueous phase of the final food or beverage product, preferably at a ratio of 0.5% parts by mass or more, more preferably 1.0% parts by mass or more, of the sweetener in terms of sucrose sweetness equivalent per part by mass of the solids content of the whey mineral.

Any foods and beverages usually manufactured using milk may be used with no problem in the above-described applications. Examples of such foods and beverages include beverages, such as coffee with milk, tea with milk, maccha-flavored milk drink, cocoa-flavored milk drink (chocolate milk), hot chocolate, and fermented milk drink; cream products, such as custard, white cream, and butter cream; creamy foods using the cream products, such as stews and gratins; desserts, such as jelly, Bavarois, and pudding; pastes, such as flour paste; margarine; dressings, such as mayonnaise; cheese-like foods; breads and buns; confectionery, such as caramels, chocolates, cookies, and ganache; ham, sausage; curry; and other processed foods.

### EXAMPLES

The invention will now be illustrated with reference to Examples, but it should be understood that the invention is not limited thereto.

### Preparation of Whey Mineral

### Preparation Example 1

Sweet whey by-produced in the cheese production was subjected to nano filtration and then concentrated by reverse osmosis filtration to a solids content of 20% by mass. The concentrate was further concentrated on an evaporator, followed by spray drying to yield whey mineral A with a solids content of 98% by mass. The resulting whey mineral A had an ash content of 35% by mass and a calcium content of 2.2% by mass on a solid basis. The protein content was 21% by mass as calculated by multiplying total nitrogen determined by the Kjeldahl method by a factor of 6.38. The fat content was less than 1% by mass as determined by the Roese-Gottlieb method.

### Preparation Example 2

Sweet whey by-produced in the cheese production was subjected to nano filtration and then concentrated by reverse osmosis filtration to a solids content of 20% by mass. The concentrate was heated at 80° C. for 20 minutes, and the precipitate thus formed was removed by centrifuge. The supernatant was further concentrated on an evaporator, followed by spray drying to yield whey mineral B with a solids content of 98% by mass. The resulting whey mineral B had an ash content of 55% by mass and a calcium content of 0.4% by mass on a solid basis. The protein content was 18% by mass as calculated by multiplying total nitrogen determined by the Kjeldahl method by a factor of 6.38. The fat content was less than 1% by mass as determined by the Roese-Gottlieb method.

### Preparation of Milk-Flavored Beverage, Milk Beverage, and Coffee Beverage

### Example 1

In 94.4 parts by mass of water were dissolved 0.6 parts by mass of whey mineral A and 5 parts by mass of lactose to prepare milk-flavored beverage A. The absorbance of milk-flavored beverage A at 660 nm was found to be 0.0150 as measured in a spectrophotometer U-3210 (from Hitachi, Ltd.) using water as a blank.

Milk-flavored beverage A had a protein content of 0.13% by mass, a fat content of less than 0.01% by mass, and a sweetener to whey mineral ratio of 1.4 parts by mass or more of the sweetener on a sucrose sweetness equivalent basis per part by mass of the solids content of the whey mineral.

Commercially available milk (protein content: 3.3% by mass; fat content: 3.8% by mass) was prepared as a control. Milk-flavored beverage A was subjected to tasting evaluation by comparison with the control. As a result, although milk-flavored beverage A was slightly inferior in body to the commercially available milk, it had the same flavor as the commercially available milk.

When milk-flavored beverage A was heated in a water bath at 80° C. for 20 minutes, a floating precipitate was formed in the aqueous solution.

### Example 2

In 94.4 parts by mass of water were dissolved 0.6 parts by mass of whey mineral B and 5 parts by mass of lactose to prepare milk-flavored beverage B. The absorbance of milk-flavored beverage B was measured in the same manner as in Example 1 and found to be less than 0.0001.

Milk-flavored beverage B had a protein content of 0.11% by mass, a fat content of less than 0.01% by mass, and a sweetener to whey mineral ratio of 1.4 parts by mass or more of the sweetener on a sucrose sweetness equivalent basis per part by mass of the solids content of the whey mineral.

Commercially available milk (protein content: 3.3% by mass; fat content: 3.8% by mass) was prepared as a control. Milk-flavored beverage B was subjected to tasting evaluation by comparison with the control. As a result, milk-flavored beverage B had almost the same flavor as the commercially available milk.

When milk-flavored beverage B was heated in a water bath at 80° C. for 20 minutes, it retained its clarity without forming a precipitate.

### Example 3

Milk-flavored beverage C was obtained in the same manner using the same formulation as in Example 2, except for changing the amount of whey mineral B from 0.6 parts to 0.2 parts by mass and the amount of water from 94.4 parts to 94.8 parts by mass. The absorbance of milk-flavored beverage C was measured in the same manner as in Example 1 and found to be less than 0.0001.

Milk-flavored beverage C had a protein content of 0.04% by mass, a fat content of less than 0.01% by mass, and a sweetener to whey mineral ratio of 4.1 parts by mass or more of the sweetener on a sucrose sweetness equivalent basis per part by mass of the solids content of the whey mineral.

Commercially available milk (protein content: 3.3% by mass; fat content: 3.8% by mass) was prepared as a control. Milk-flavored beverage C was subjected to tasting evaluation by comparison with the control. As a result, although milk-flavored beverage C was slightly inferior in body to the commercially available milk, it had almost the same flavor as the commercially available milk.

When milk-flavored beverage C was heated in a water bath at 80° C. for 20 minutes, it retained its clarity without forming a precipitate.

### Example 4

In 77.5 parts by mass of water were dissolved 4.5 parts by mass of whey mineral B, 10.0 parts by mass of lactose, and 8.3 parts by mass of sucrose to prepare milk-flavored beverage D. The absorbance of milk-flavored beverage D was found to be less than 0.0001 as measured in the same manner as in Example 1.

Milk-flavored beverage D had a protein content of 0.81% by mass, a fat content of less than 0.05% by mass, and a sweetener to whey mineral ratio of 2.2 parts by mass or more of the sweetener on a sucrose sweetness equivalent basis per part by mass of the solids content of the whey mineral.

Commercially available milk (protein content: 3.3% by mass; fat content: 3.8% by mass) was prepared as a control. Milk-flavored beverage D was subjected to tasting evaluation by comparison with the control. As a result, although milk-flavored beverage D was slightly stronger in body than the commercially available milk, it had almost the same flavor as the commercially available milk.

When milk-flavored beverage D was heated in a water bath at 80° C. for 20 minutes, it retained its clarity without forming a precipitate.

### Example 5

Milk-flavored beverage E was obtained in the same manner using the same formulation as in Example 2, except for changing 5 parts by mass of lactose to 0.9 parts by mass of white superior soft sugar and changing the amount of water from 94.4 parts to 98.5 parts by mass. The absorbance of milk-flavored beverage E was measured in the same manner as in Example 1 and found to be less than 0.0001.

Milk-flavored beverage E had a protein content of 0.11% by mass, a fat content of less than 0.01% by mass, and a sweetener to whey mineral ratio of 1.5 parts by mass or more of the sweetener on a sucrose sweetness equivalent basis per part by mass of the solids content of the whey mineral.

Commercially available milk (protein content: 3.3% by mass; fat content: 3.8% by mass) was prepared as a control. Milk-flavored beverage E was subjected to tasting evaluation by comparison with the control. As a result, although milk-flavored beverage E was slightly weaker in sweet taste than the commercially available milk, it had almost the same flavor as the commercially available milk.

When milk-flavored beverage E was heated in a water bath at 80° C. for 20 minutes, it retained its clarity without forming a precipitate.

### Example 6

Milk-flavored beverage F was obtained in the same manner using the same formulation as in Example 2, except for changing 5 parts by mass of lactose to 0.004 parts by mass of acesulfame potassium and changing the amount of water from 94.4 parts to 99.393 parts by mass. The absorbance of milk-flavored beverage F was measured in the same manner as in Example 1 and found to be less than 0.0001.

Milk-flavored beverage F had a protein content of 0.11% by mass, a fat content of less than 0.01% by mass, and a sweetener to whey mineral ratio of 1.3 parts by mass or more of the sweetener on a sucrose sweetness equivalent basis per part by mass of the solids content of the whey mineral.

Commercially available milk (protein content: 3.3% by mass; fat content: 3.8% by mass) was prepared as a control. Milk-flavored beverage F was subjected to tasting evaluation by comparison with the control. As a result, although milk-flavored beverage F was slightly different in nature of sweetness from the commercially available milk, it had almost the same flavor as the commercially available milk.

When milk-flavored beverage F was heated in a water bath at 80° C. for 20 minutes, it retained its clarity without forming a precipitate.

### Example 7

Milk-flavored beverage G was obtained in the same manner using the same formulation as in Example 2, except for changing 5 parts by mass of lactose to 0.001 parts by mass of acesulfame potassium, 0.0006 parts by mass of sucralose, 1.1 parts by mass of reduced starch syrup (powder), and 1.8 parts by mass of indigestible dextrin and changing the amount of water from 94.4 parts to 96.4984 parts by mass. The absorbance of milk-flavored beverage G was measured in the same manner as in Example 1 and found to be less than 0.0001.

Milk-flavored beverage G had a protein content of 0.11% by mass, a fat content of less than 0.01% by mass, and a sweetener to whey mineral ratio of 1.5 parts by mass or more of the sweetener on a sucrose sweetness equivalent basis per part by mass of the solids content of the whey mineral.

Commercially available milk (protein content: 3.3% by mass; fat content: 3.8% by mass) was prepared as a control. Milk-flavored beverage G was subjected to tasting evaluation by comparison with the control. As a result, milk-flavored beverage G had almost the same flavor as the commercially available milk.

When milk-flavored beverage G was heated in a water bath at 80° C. for 20 minutes, it retained its clarity without forming a precipitate.

### Example 8

Commercially available milk (protein content: 3.3% by mass; fat content: 3.8% by mass) and milk-flavored beverage B obtained in Example 2 were mixed in a mass ratio of 25:75 to make milk beverage A according to the invention, in which 75% of the milk had been substituted with the milk-flavored beverage of the invention.

The same commercially available milk as used above was prepared as a control. Milk beverage A was subjected to tasting evaluation by comparison with the control. As a result, milk beverage A had almost the same body and flavor as the commercially available milk.

### Example 9

Commercially available milk (protein content: 3.3% by mass; fat content: 3.8% by mass) and milk-flavored beverage B obtained in Example 2 were mixed in a mass ratio of 50:50 to make milk beverage B according to the invention having 50% of the milk replaced by the milk-flavored beverage of the invention.

The same commercially available milk as used above was prepared as a control. Milk beverage B was subjected to tasting evaluation by comparison with the control. As a result, milk beverage B had almost the same body and flavor as the commercially available milk.

### Example 10

Commercially available milk (protein content: 3.3% by mass; fat content: 3.8% by mass) and milk-flavored beverage B obtained in Example 2 were mixed in a mass ratio of 75:25 to make milk beverage C according to the invention having 25% of the milk replaced with the milk-flavored beverage of the invention.

The same commercially available milk as used above was prepared as a control. Milk beverage C was subjected to tasting evaluation by comparison with the control. As a result, milk beverage C had almost the same body and flavor as the commercially available milk.

### Comparative Example 1

Milk-flavored beverage H was obtained in the same manner using the same formulation as in Example 2, except for changing the amount of whey mineral B from 0.6 parts to 0 part by mass and changing the amount of water from 94.4 parts to 95 parts by mass. The absorbance of milk-flavored beverage H was measured in the same manner as in Example 1 and found to be less than 0.0001.

Commercially available milk (protein content: 3.3% by mass; fat content: 3.8% by mass) was prepared as a control, and milk-flavored beverage H was subjected to tasting evaluation by comparison with the control. As a result, milk-flavored beverage H was found to have no flavor of milk.

### Comparative Example 2

Milk-flavored beverage I was obtained in the same manner using the same formulation as in Example 2, except for changing the amount of lactose from 5 parts to 0 part by mass and changing the amount of water from 94.4 parts to 99.4 parts by mass. The absorbance of milk-flavored beverage I was measured in the same manner as in Example 1 and found to be less than 0.0001.

Commercially available milk (protein content: 3.3% by mass; fat content: 3.8% by mass) was prepared as a control, and milk-flavored beverage I was subjected to tasting evaluation by comparison with the control. As a result, milk-flavored beverage I was tasted strongly bitter, gave off an unpleasant odor, and had no flavor of milk.

### Example 11

Forty grams of commercially available regular coffee (ground) was extracted with 700 g of hot water to obtain a coffee extract. To 420 g of the coffee extract were added 30 g of sugar and 50 g of milk-flavored beverage B obtained in Example 2 and dissolved by stirring to make coffee beverage A. While coffee beverage A had the color of rich black coffee, it had a milk flavor like coffee with milk.

Subsequently, coffee beverage A was put in a closed container and sterilized by heating at 123° C. for 20 minutes, whereupon coffee beverage A formed no sediment or turbidity and had the same flavor as before the heat sterilization.

Coffee beverage A as prepared above was stored at 60° C. for 30 days, whereupon change in flavor was not detected.

### Example 12

Coffee beverage B was prepared in the same manner using the same formulation as in Example 11, except for changing 50 g of milk-flavored beverage B with 50 g of milk beverage B obtained in Example 8.

As a control, coffee beverage C was prepared in the same manner using the same formulation as in Example 11, except for changing 50 g of milk-flavored beverage B with 50 g of commercially available milk (protein content: 3.3% by mass; fat content: 3.8% by mass). Coffee beverages B and C were compared by tasting. Coffee beverage B was found to have almost the same milk flavor as coffee beverage C and a stronger coffee flavor than coffee beverage C.

### Example 13

Coffee beverage D was prepared in the same manner using the same formulation as in Example 11, except that 30 g of sugar was not added. The resulting coffee beverage D had the color of rich black coffee, yet with a milk flavor like coffee with milk.

### Example 14

Coffee beverage E was prepared in the same manner using the same formulation as in Example 11, except for changing 50 g of milk-flavored beverage B with 50 g of milk-flavored beverage G obtained in Example 7 and replacing 30 g of sugar with 0.035 parts by mass of acesulfame potassium and 0.035 parts by mass of sucralose. The resulting coffee beverage E had the color of rich black coffee, yet with a milk flavor like coffee with milk.

1. A milk-flavored beverage comprising whey mineral and a sweetener and containing substantially no protein and substantially no fat and oil.

2. The milk-flavored beverage according to claim 1, wherein the whey mineral is present in an amount of 0.1% to 5% by mass on a solid basis.

3. The milk-flavored beverage according to claim 1, wherein the whey mineral has a calcium content of less than 2% by mass relative to the solids content of the whey mineral.

4. The milk-flavored beverage according to claim 1, wherein the sweetener is present in an amount of 0.08% to 12% on a sucrose sweetness equivalent basis.

5. The milk-flavored beverage according to claim 1, wherein a part of or the whole of the sweetener is lactose.

6. The milk-flavored beverage according to claim 1, wherein a part of or the whole of the sweetener is a high intensity sweetener.

7. The milk-flavored beverage according to claim 1, having an absorbance of 0.1 or less at 660 nm.

8. A food or beverage comprising the milk-flavored beverage according to claim 1.

9. The food or beverage according to claim 8, which is a coffee beverage.

10. A milk beverage comprising milk and having the milk partly substituted with the milk-flavored beverage.

11. A method for producing a food or beverage comprising milk, comprising substituting part of the milk with the milk-flavored beverage according to claim 1.

12. The milk-flavored beverage according to claim 2, wherein the whey mineral has a calcium content of less than 2% by mass relative to the solids content of the whey mineral.

13. The milk-flavored beverage according to claim 2, wherein the sweetener is present in an amount of 0.08% to 12% on a sucrose sweetness equivalent basis.

14. The milk-flavored beverage according to claim 3, wherein the sweetener is present in an amount of 0.08% to 12% on a sucrose sweetness equivalent basis.

15. The milk-flavored beverage according to claim 2, wherein a part of or the whole of the sweetener is lactose.

16. The milk-flavored beverage according to claim 3, wherein a part of or the whole of the sweetener is lactose.

17. The milk-flavored beverage according to claim 4, wherein a part of or the whole of the sweetener is lactose.

18. The milk-flavored beverage according to claim 2, wherein a part of or the whole of the sweetener is a high intensity sweetener.

19. The milk-flavored beverage according to claim 3, wherein a part of or the whole of the sweetener is a high intensity sweetener.

20. The milk-flavored beverage according to claim 4, wherein a part of or the whole of the sweetener is a high intensity sweetener.
